(19) United States
(12) Patent Application Publication
(10) Pub. No.: US 2011/0138596 A1
(43) Pub. Date: Jun. 16, 2011

(54) METHOD OF REPAIRING MEMBER

(76) Inventors: Katsumi Namba, Takasago-shi (JP); Ikuo Okada, Takasago-shi (JP); Taiji Torigoe, Takasago-shi (JP); Ichiro Ichihashi, Sagamihara-shi (JP); Tomohiro Ono, Sagamihara-shi (JP); Motoyoshi Nakamura, Sagamihara-shi (JP)

(21) Appl. No.: 12/920,994

(22) PCT Filed: Sep. 11, 2008
(86) PCT No.: PCT/JP2008/066376

§ 371 Date: Nov. 9, 2010

(30) Foreign Application Priority Data
Mar. 19, 2008 (JP) 2008-070564

(51) Int. Cl. B23P 6/04

(52) U.S. Cl. 29/402.18

(57) ABSTRACT

A bond layer 11 is formed by thermally spraying a Ni—Al alloy on a worn portion of a member 10, and thereafter, a buildup layer 12 is formed by thermally spraying a stainless steel onto the bond layer 11.

### TECHNICAL FIELD

The present invention relates to a method of repairing a worn member.

### BACKGROUND ART

For example, in a diesel engine which is an internal combustion engine, as shown in FIG. 4, a crankcase 101 made of cast iron and a cylinder head 102 made of cast iron are fixed to each other with a gasket 103 made of carbon steel (for example, a SS400 equivalent steel, an SPCC (JIS G3141) or the like) interposed in between by tightening a clamp bolt 104. Note that reference numeral 105 in FIG. 4 denotes a liner.
Patent Document 1: Japanese Patent Application Publication No. Hei 5-302674
Patent Document 2: Japanese Patent Application Publication No. Hei 7-197850
Patent Document 3: Japanese Patent Application Publication No. Hei 10-299568
Patent Document 4: Japanese Patent Application Publication No. 2004-256913

### DISCLOSURE OF THE INVENTION

### Problems to be Solved by the Invention

In such a diesel engine, if the clamp bolt 104 becomes even slightly loose over use, the crankcase 101 and the cylinder head 102 rub against the gasket 103, so that the end faces, which are in contact with the gasket 103, of the crankcase 101 and the cylinder head 102 are worn out. This creates a gap between the crankcase 101 and the cylinder head 102.

When the crankcase 101 and the cylinder head 102 are worn as described above, the crankcase 101 and the cylinder head 102 are discarded to be replaced with new ones. The replacement results not only in waste of resources but also in high costs.

Such a problem is not limited to the crankcase 101 and the cylinder head 102 of the diesel engine described above, and may similarly arise regarding any member made of a metal material.

Under these circumferences, an object of the present invention is to provide a method of repairing a member, the method allowing reuse of a worn member made of a metal material.

### Means for Solving the Problems

A method of repairing a member according to a first aspect of the invention for solving the above-described problems is a method of repairing a worn member made of metal, the method characterized by comprising: forming a bond layer by thermally spraying an Ni—Al alloy onto a worn portion of the member; and then, forming a buildup layer by thermally spraying a stainless steel onto the bond layer.

A method of repairing a member according to a second aspect of the present invention in view of the first aspect of the present invention is characterized in that the member is made of cast iron.

A method of repairing a member according to a third aspect of the present invention in view of the first aspect or the second aspect of the present invention is characterized in that the stainless steel is a Cr stainless steel.

A method of repairing a member according to a fourth aspect of the present invention in view of any one of the first aspect to the third aspect of the present invention is characterized in that the buildup layer has a thickness of 0.1 mm to 3 mm.

A method of repairing a member according to a fifth aspect of the present invention in view of any one of the first aspect to the fourth aspect of the present invention is characterized in that thermal spraying is performed by an arc wire spraying method.

A method of repairing a member according to a sixth aspect of the present invention in view of any one of the first aspect to the fifth aspect of the present invention is characterized in that the member is a member forming an internal combustion engine.

### Effects of the Invention

With the method of repairing a member according to the present invention, the buildup layer is formed with the bond layer interposed between the buildup layer and the member. Accordingly, the buildup layer can be firmly and closely attached to the bond layer, and thus detachment of the buildup layer can be reliably prevented. Consequently, it is possible to reuse the worn member.

### BRIEF DESCRIPTION OF THE DRAWINGS

FIG. 1 shows a diagram illustrating repairing procedures in a main embodiment of a method of repairing a member according to the present invention.

FIG. 2 shows a schematic configuration diagram of a main part of an arc wire welder used in the main embodiment of the method of repairing a member according to the present invention.

FIG. 3 shows a graph representing a result of a check test performed to confirm an effect of the method of repairing a member according to the present invention.

FIG. 4 shows an enlarged cross-sectional diagram of an extracted abutment portion between a crankcase and a cylinder head of a diesel engine.

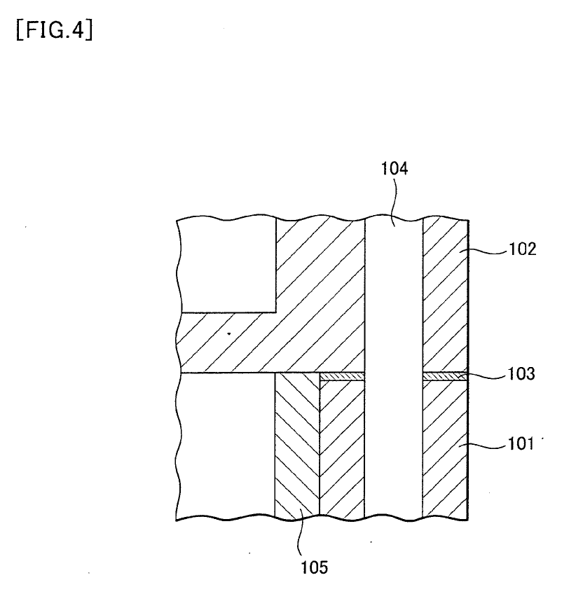

### BEST MODES FOR CARRYING OUT THE INVENTION

Embodiments of a method of repairing a member according to the present invention will be described below based on the drawings. However, the present invention is not limited to only the embodiments to be described below based on the drawings.

### Main Embodiment

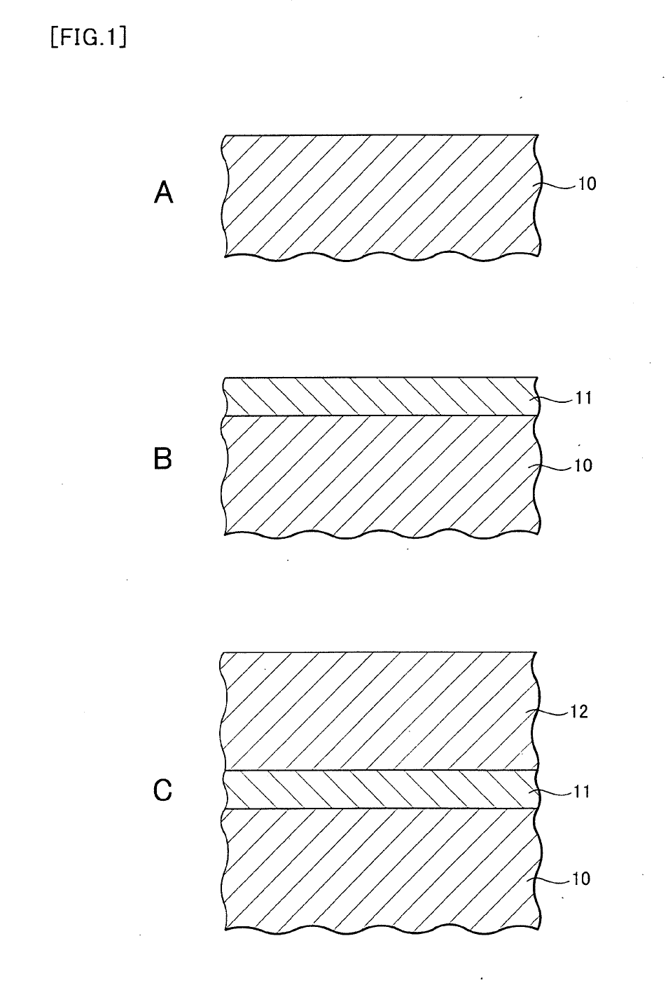

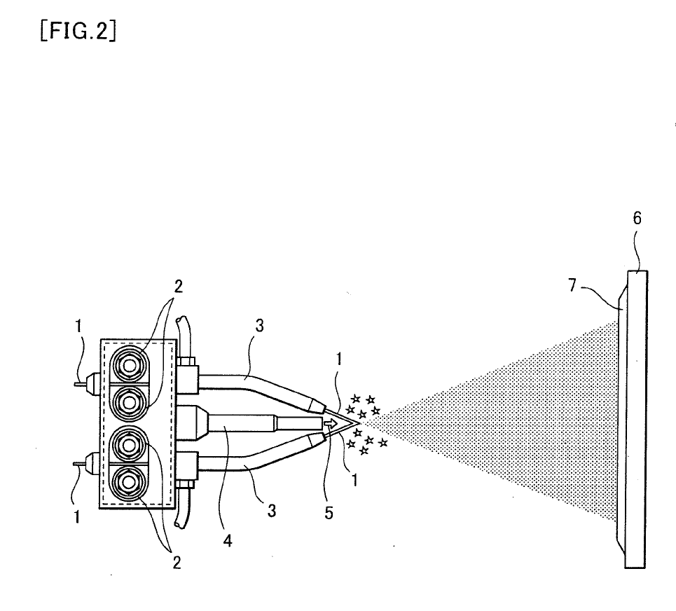

A main embodiment of the method of repairing a member according to the present invention will be described based on FIG. 1 and FIG. 2. FIG. 1 is a diagram illustrating repairing procedures of the method of repairing a member. FIG. 2 is a schematic configuration diagram of a main part of an arc wire welder.

The method of repairing a member according to the present invention is a method of repairing a member 10 made of cast iron as a metal material and having been worn, as shown in FIG. 1 (see FIG. 1A). In the method, a Ni—Al alloy is thermally sprayed onto a worn portion of the member 10 by an arc wire spraying method so as to form a bond layer 11 (see FIG. 1B). Thereafter, a Cr stainless steel is thermally sprayed onto the bond layer 11 by the arc wire spraying method so as to form a buildup layer 12 (see FIG. 1C).

The arc wire spraying method is implemented as shown in FIG. 2. Specifically, a pair of wires 1 made of a material to be thermally sprayed is fed from respective base ends of a pair of wire guide nozzles 3 to respective tip ends thereof by using two pairs of wire feed rolls 2, and then brought into contact with each other. At the same time, a direct current voltage is applied between the paired wire guide nozzles 3. Thereby, an arc is generated at the tip ends of the wires 1 brought into contact with each other, and the tip ends of the wires 1 are melted. The melted material of the wires 1 are thermally sprayed onto a thermal sprayed body 6 by injecting compressed air 5 from an air nozzle 4, and thus a thermal sprayed layer 7 is formed.

By such an arc wire spraying method, in the member 10 having the buildup layer 12 formed thereon with the bond layer 11 interposed in between, the buildup layer 12 can be firmly and closely attached to the bond layer 11. Therefore, detachment of the buildup layer 12 can be reliably prevented.

Hence, suppose a case where the aforementioned repairing is performed on, for example, the worn portions in the case described in Background Art in which the portions of the crankcase 101 (made of cast iron) and the cylinder head 102 (made of cast iron) in the diesel engine, which is an internal combustion engine, are worn due to the friction with the gasket 103 (made of a carbon steel (for example, made of a SS400 equivalent steel, an SPCC (JIS G3141) or the like)). In this case, in a diesel engine reusing the crankcase 101 and the cylinder head 102, even though load due to operation of the diesel engine is applied to the buildup layer 12, detachment of the buildup layer 12 does not occur and thus the diesel engine can be used safely.

Consequently, with the method of repairing a member according to the present invention, the worn member 10 can be reused.

In addition, suppose a case where, in the diesel engine reusing the crankcase 101 and the cylinder head 102 which have been subjected to the aforementioned repairing, the crankcase 101 and the cylinder head 102 rub against the gasket 103 again because the clamp bolt 104 even slightly becomes loose over use, as described in Background Art. In this case, since the buildup layer 12 is harder than the gasket 103, the buildup layer 12 is not worn but the gasket 103 is worn.

For this reason, even though a gap is created again between the crankcase 101 and the cylinder head 102, the crankcase 101 and the cylinder head 102 do not have to be repaired, and what is needed is only to replace the low-cost gasket 103 with a new one. Thus, it is possible to considerably reduce labor and cost of repairing again the diesel engine having been subjected to the aforementioned repairing.

Meanwhile, the thickness of the buildup layer 12 may be appropriately set depending on the needs. However, the thickness is preferably set within a range of 0.1 mm to 3 mm. This is because a thickness of less than 0.1 mm is too thin and the bond layer 11 might be exposed, while a thickness of more than 3 mm is likely to cause a transverse crack and to thereby deteriorate the adhesion.

In addition, although not particularly limited, the thickness of the bond layer 11 is preferably set to be approximately 0.1 mm. This is because the thickness significantly less than 0.1 mm is likely to cause a base material of the member 10 to be exposed and to thereby inhibit the bond layer 11 from exhibiting its function, while the thickness significantly larger than 0.1 mm results in waste of the material of the bond layer 11.

### Other Embodiments

In the embodiment described above, the description has been given of the case where a Cr stainless steel is thermally sprayed to form the buildup layer 12 and thereby the member 10 is repaired. However, the present invention is not limited to this. As another embodiment, for example, another stainless steel such as a Cr—Ni stainless steel may be thermally sprayed to form a buildup layer, and thereby a member may be repaired.

In addition, in the embodiment described above, the description has been given of the case where the crankcase 101 and the cylinder head 102 which are worn in the diesel engine are repaired. However, the present invention is not limited to this. As another embodiment, even in a case of a member, such as a crankcase and a cylinder head, which is worn in, for example, a gasoline engine which is another internal combustion engine, it is obviously possible to obtain the same operations and effects as in the embodiment described above. Furthermore, as long as it is a case where a worn member made of a metal material is repaired, the present invention can be applied to the case in the same manner as in the case of the embodiment described above. In particular, in a case where a worn member made of cast iron is repaired, it is possible to obtain the same operations and effects as in the case of the embodiment described above at a significant level. Thus, it is very preferable.

### Example

In order to check the effects of the method of repairing a member according to the present invention, the following check test was carried out.

### [Test Piece Preparation]

An Ni—Al alloy was thermally sprayed onto a base material made of a cast iron (FC250) by the arc wire spraying method to form a bond layer (thickness: 0.1 mm). Thereafter, a Cr stainless steel (13Cr stainless steel (SUS 410)) was thermally sprayed by the arc wire spraying method to form a buildup layer (thickness: 0.1 mm to 6 mm). Thereby, various test pieces having the buildup layers with different thicknesses were prepared. Note that the size of the base materials was changed as appropriate, depending on the thickness of the buildup layer. To be more specific, for example, when the thickness of the buildup layer was 0.1 mm, a base material having a thickness of 1.4 mm, a length of 40 mm and a width of 3 mm was used. When the thickness of the buildup layer was 3 mm, a base material having a thickness of 4 mm, a length of 100 mm and a width of 15 mm was used. When the thickness of the buildup layer was 6 mm, a base material having a thickness of 16 mm, a length of 150 mm and a width of 50 mm was used.

### [Test Method]

A strain meter is arranged on a buildup layer of a test piece. After both ends of the test piece on the buildup layer side are held, a load is gradually applied to a center portion of the test piece on the base material side (three-point bending test). Then, a strain distribution upon occurrence of a transverse crack in the buildup layer was found, while a tip end position of the transverse crack was determined by observation of a cross-sectional microstructure of the test piece, and a surface strain (detachment limit strain) at the tip end position was calculated. Note that the limit of the strain measurement was set to 1.2% (because the strain of this value or larger causes a crack in the base material, and thereby should not be taken into consideration).

### [Test Results]

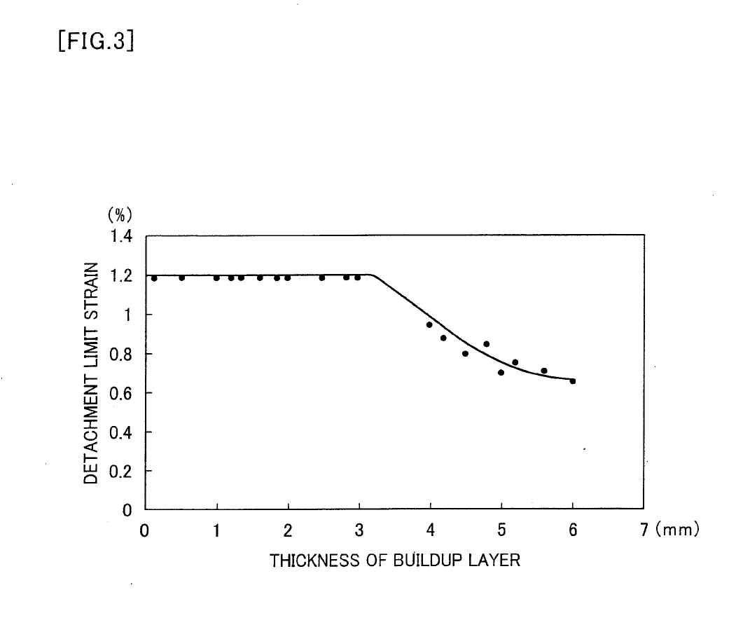

FIG. 3 shows a relationship between the detachment limit strains obtained by the above-described test method and the thicknesses of the buildup layer.

As is clear from FIG. 3, when the thickness of the buildup layer was 3 mm or less, even the strain of 1.2% did not cause a transverse crack in the buildup layer. However, when the thickness of the buildup layer exceeded 3 mm, a trend was observed that the detachment limit strain gradually decreases less than 1.2%.

Therefore, it was confirmed that, when the thickness of the buildup layer is 3 mm or less, the buildup layer can be firmly and closely attached to the base material, and detachment of the buildup layer from the base material can be reliably prevented.

### INDUSTRIAL APPLICABILITY

The method of repairing a member according to the present invention allows reuse of a worn member, and thus can be utilized extremely usefully in various industries.

1. A method of repairing a member, the method being a method of repairing a worn member made of a metal material, the method comprising:
forming a bond layer by thermally spraying an Ni—Al alloy onto a worn portion of the member; and then,
forming a buildup layer by thermally spraying a stainless steel onto the bond layer.

2. The method of repairing a member according to claim 1, wherein the member is made of cast iron.

3. The method of repairing a member according to claim 1, wherein stainless steel is a Cr stainless steel.

4. The method of repairing a member according to claim 1, wherein the buildup layer has a thickness of 0.1 mm to 3 mm.

5. The method of repairing a member according to claim 1, wherein thermal spraying is performed by an arc wire spraying method.

6. The method of repairing a member according to claim 1, wherein the member is a member forming an internal combustion engine.
